(19) United States
(12) Patent Application Publication
(10) Pub. No.: US 2025/0270062 A1
(43) Pub. Date: Aug. 28, 2025

(54) CONVEYANCE STATE DETERMINATION SYSTEM AND STORAGE MEDIUM

(71) Applicant: Konica Minolta, Inc., Tokyo (JP)

(72) Inventors: Kouei CHO, Toyohashi-shi (JP); Yuta TACHIBANA, Toyokawa-shi (JP); Tadayuki UEDA, Tokyo (JP); Shoichi TAO, Tokyo (JP)

(21) Appl. No.: 19/062,332

(22) Filed: Feb. 25, 2025

(30) Foreign Application Priority Data
Feb. 26, 2024 (JP) 2024-026203

(51) Int. Cl. B65H 7/02; G03G 15/00

(52) U.S. Cl. CPC B65H 7/02; G03G 15/6529; B65H 2513/10; B65H 2801/06; G03G 2215/00746

(57) ABSTRACT

Provided is a conveyance state determination system including a controller. The controller acquires actual state information corresponding to a speed change of a sheet on a conveyance path of the sheet based on detection results of a plurality of sheet detection sensors disposed on the conveyance path. The controller acquires reference state information to be compared with the actual state information. The controller compares the actual state information and the reference state information to output evaluation information for evaluating a state of a conveyance device that conveys the sheet through the conveyance path.

### CROSS-REFERENCE TO RELATED APPLICATIONS

The present invention claims priority under 35 U.S.C. § 119 to Japanese Application No. 2024-026203 filed Feb. 26, 2024, the entire content of which is incorporated herein by reference.

### BACKGROUND OF THE INVENTION

### Technical Field

The present invention relates to a conveyance state determination system and a storage medium.

### Description of Related Art

Conventionally, image forming devices that form images on sheets have been known. In an image forming device, problems may occur in conveyance of a sheet depending on a state of the image forming device.

In this regard, Japanese Unexamined Patent Publication No. 2007-323455 discloses a technique of calculating, diagnosing, and displaying the degree of risk of a failure by collecting and analyzing jam information in order to prevent a failure of an image forming device in advance.

However, the invention described in JP2007323455A is a method of analyzing information on a jam when the jam has already occurred. Therefore, since it is difficult to prevent a jam in advance, there is a problem that a waste of sheets occurs due to the jam. Further, since it is difficult to prevent a jam in advance, there is a problem that the image forming device is stopped due to the jam and the productivity is lowered.

An object of the present invention is to provide a conveyance state determination system and a storage medium storing a program that can suppress a waste of sheets and a reduction in productivity.

### SUMMARY OF THE INVENTION

To achieve at least one of the abovementioned objects, according to an aspect of the present invention, a conveyance state determination system reflecting one aspect of the present invention includes:
a controller,
wherein the controller:
   acquires actual state information corresponding to a speed change of a sheet on a conveyance path of the sheet based on detection results of a plurality of sheet detection sensors disposed on the conveyance path;
   acquires reference state information to be compared with the actual state information; and
   compares the actual state information and the reference state information to output evaluation information for evaluating a state of a conveyance device that conveys the sheet through the conveyance path.

According to another aspect of the present invention, a non-transitory computer-readable storage medium storing a program for causing a computer to function as:
a first acquirer that acquires actual state information corresponding to a speed change of a sheet on a conveyance path of the sheet based on detection results of a plurality of sheet detection sensors disposed on the conveyance path;
a second acquirer that acquires reference state information to be compared with the actual state information; and
an output section that outputs evaluation information for evaluating a state of a conveyance device that conveys the sheet through the conveyance path by comparing the actual state information and the reference state information.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 shows a schematic configuration of an image forming system according to the present embodiment;

FIG. 2 is a functional block diagram showing a control structure of the image forming system according to the present embodiment.

FIG. 3A is a diagram showing an example of a detection signal of a sheet detection sensor.

FIG. 3B is a diagram showing timings when leading or rear ends of sheets is detected by a sheet detection sensor.

FIG. 4 is a diagram showing an example of a data set acquired by sheet detection sensors.

FIG. 5 is a flowchart showing conveyance state determination processing.

FIG. 6 is a flowchart showing conveyance state determination processing of Modification Example 1.

FIG. 7 is a flowchart showing conveyance state determination processing of Modification Example 2.

FIG. 8 is a flowchart showing conveyance state determination processing of Modification Example 3.

FIG. 9 shows an example of a display screen displayed on a display part.

FIG. 10 shows an example of a correction coefficient table.

FIG. 11 is a flowchart showing conveyance state determination processing of Modification Example 4.

### DETAILED DESCRIPTION

Hereinafter, one or more embodiments of the present invention will be described with reference to the drawings. However, the scope of the invention is not limited to the disclosed embodiments.

### 1. Configuration of Image Forming System

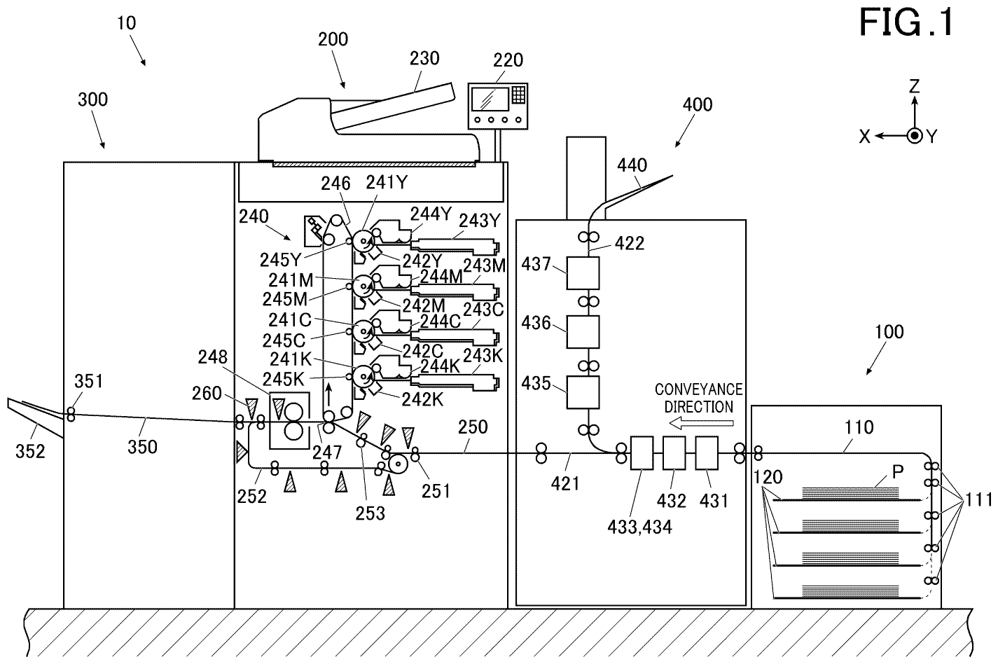

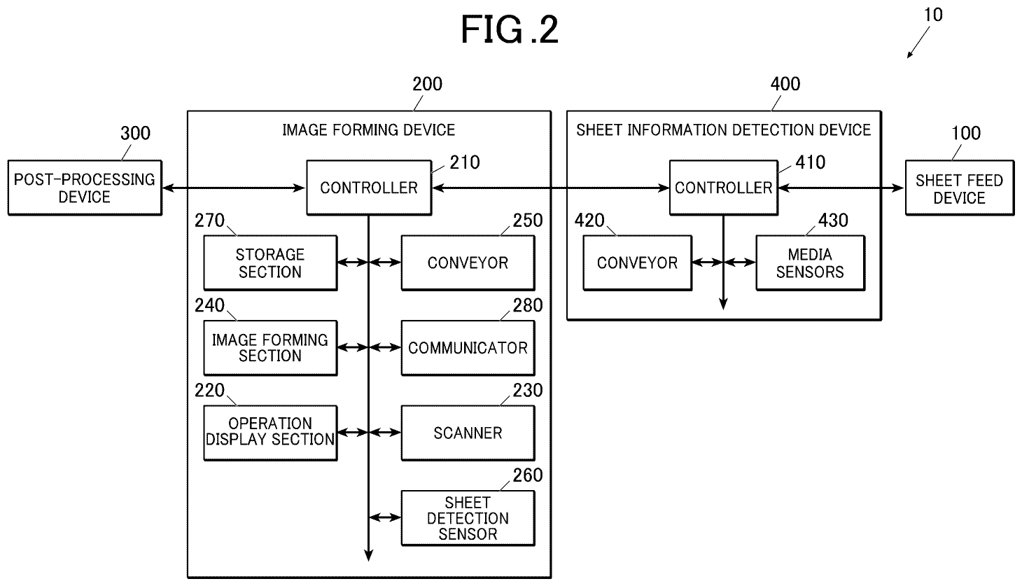

FIG. 1 shows a schematic configuration of an image forming system 10 according to the present embodiment. FIG. 2 is a functional block diagram showing a control structure of the image forming system 10.

As shown in FIGS. 1 and 2, the image forming system 10 as a conveyance state determination system according to the present embodiment includes a sheet feed device 100, a sheet information detection device 400, an image forming device 200, and a post-processing device 300. In the image forming system 10, the sheet feed device 100, the sheet information detection device 400, the image forming device 200, and the post-processing device 300 are connected in this order along the conveyance direction of a sheet P.

The image forming system 10 supplies the sheet P loaded in the sheet feed device 100 to the image forming device 200 via the sheet information detection device 400. Next, the image forming system 10 forms an image on the sheet P by the image forming device 200, and then conveys the sheet P out of the image forming device 200 to the post-processing device 300. Next, the image forming system 10 performs predetermined post-processing on the sheet P after the image forming processing by the post-processing device 300, and then discharges the sheet P from the post-processing device 300.

### 1-1. Configuration of Sheet Feed Device

In the image forming system 10, the sheet feed device 100 stores sheets P for image formation and feeds a sheet P to the image forming device 200 via the sheet information detection device 400 in accordance with an image forming job. As shown in FIG. 1, the sheet feed device 100 includes a conveyor 110 and sheet feed sections 120.

The sheet feed sections 120 includes, for example, a plurality of sheet feed trays arranged in the sheet feed device 100. Each of the sheet feed sections 120 can load a plurality of sheets P in a stacked state. In the example shown in FIG. 1, the sheet feed device 100 includes four sheet feed sections 120 arranged one above the other. The sheet feed sections 120 individually accommodate sheets different in type, size, and the like.

The conveyor 110 includes a pickup roller (not illustrated) that picks up the sheet P from each of the sheet feed sections 120, a plurality of conveyance rollers 111 that are provided along a predetermined conveyance path to convey the sheet P, and the like. The conveyance path of the conveyor 110 includes the plurality of sheet feed sections 120 merged into one path and is connected to the sheet information detection device 400.

Thus, the conveyor 110 drives the conveyance rollers 111 to convey the sheet P fed from the sheet feed section 120 to the sheet information detection device 400.

### 1-2. Configuration of Sheet Information Detection Device

The sheet information detection device 400 is connected subsequently to the sheet feed device 100. The sheet information detection device 400 includes a controller 410 (hardware processor), a conveyor 420, and medium sensors 430.

The controller 410 includes a central processing unit (CPU), a random access memory (RAM), and the like, and comprehensively controls operation of each section of the sheet information detection device 400.

The conveyor 420 includes a plurality of roller pairs and conveys the sheet P conveyed from the sheet feed device 100 to the image forming device 200 or the purge tray 440. The conveyor 420 includes a conveyance path 421 connected to the image forming device 200, and a conveyance path 422 that branches from the conveyance path 421 and is connected to the purge tray 440.

The media sensors 430 detect sheet characteristic information which is a physical property value of the sheet P or a value indicating the characteristics such as a current or a voltage of the sensor corresponding to the physical property value of the sheet P. The sheet characteristic information is information corresponding to the characteristics of the sheet P.

The media sensors 430 include a size sensor 431, a paper thickness sensor 432, a basis weight sensor 433, and a moisture content sensor 434 on the conveyance path 421. The size sensor 431, the sheet thickness sensor 432, the basis weight sensor 433, and the moisture content sensor 434 detect sheet characteristic information corresponding to a size, a sheet thickness, a basis weight, and a moisture content, respectively, while the sheet P is being conveyed on the conveyance path 421 without being stopped at a conveyance speed during image formation.

The media sensors 430 include a stiffness sensor 435, a surface property sensor 436, and a resistance sensor 437 on the conveyance path 422. The stiffness sensor 435 and the surface property sensor 436 are arranged on the upstream side of (below) the resistance sensor 437. In the example shown in FIG. 1, the stiffness sensor 435 and the surface property sensor 436 are arranged in this order in the conveyance direction (Z direction), but this arrangement order may be reversed. The stiffness sensor 435, the surface property sensor 436, and the resistance sensor 437 stop the sheet P at their respective sensor positions to perform detection and feed the sheet P to the next sensor on the downstream side. The conveyor 420 ejects the sheet P on which the measurements by the stiffness sensor 435, the surface property sensor 436, and the resistance sensor 437 have been completed to a purge tray 440 without conveying the sheet P to the image forming device 200.

The size sensor 431 is disposed on the most upstream side among the media sensors 430. The size sensor 431 measures a physical quantity corresponding to the size of the sheet P and outputs a measurement result. The size sensor 431 is, for example, an image sensor and detects the edge of the sheet by imaging the sheet P being conveyed.

The sheet thickness sensor 432 is disposed second from the upstream among the media sensors 430. The sheet thickness sensor 432 measures a physical quantity corresponding to the thickness of a sheet and outputs a measurement result.

The basis weight sensor 433 and the moisture content sensor 434 are arranged on the downstream side of the sheet thickness sensor 432. The basis weight sensor 433 and the moisture content sensor 434 are disposed side by side at the same position in the conveyance direction (X direction) of the sheet P and at different positions in the width direction (Y direction).

The basis weight sensor 433 measures a physical quantity corresponding to the basis weight of a sheet and outputs a measurement result.

The moisture content sensor 434 measures a physical quantity corresponding to the amount of moisture (moisture percentage) of a sheet and outputs a measurement result.

The stiffness sensor 435 measures a physical quantity corresponding to the stiffness of a sheet P and outputs a measurement result.

The surface property sensor 436 measures presence or absence of coating on the surface of the sheet P, a type of coating if coating is present, and surface properties such as surface roughness or smoothness, and outputs measurement results.

The resistance sensor 437 measures an electrical resistance of the sheet P and outputs a measurement result.

### 1-3. Configuration of Image Forming Device

The image forming device 200 is connected subsequently to the sheet information detection device 400. The image forming device 200 forms an image on the sheet P conveyed from the sheet information detection device 400. The image forming device 200 includes a controller 210 (hardware processor), an operation display section 220, a scanner 230, an image forming section 240, a conveyor 250, sheet detection sensors 260, a storage section 270, and a communicator 280.

The controller 210 includes a CPU and a memory and controls the entire image forming device 200. The CPU is a control circuit configured by a multi-core processor or the like that executes control of each unit described above, various kinds of arithmetic processing, and the like according to a program. Each function of the image forming device 200 is achieved by the CPU executing a corresponding program. The memory is a high-speed accessible main storage device that temporarily stores programs and data as a work area. The memory is, for example, a DRAM, an SDRAM, or an SRAM.

In the present embodiment, the controller 210 controls the sheet feed device 100. The controller 210 controls the sheet information detection device 400 via the controller 410. The controller 210 controls the post-processing device 300.

The operation display section 220 includes an operation part and a display.

The display includes a display device such as a liquid crystal display (LCD), for example, and displays various screens in accordance with commands of display signals input from the controller 210.

The operation part includes a touch screen formed so as to cover a display screen of the display part, and various operation buttons such as numeric buttons and a start button. The operation part outputs, to the controller 210, an operation signal based on the user operation. The operation part accepts an operation command from the user.

The scanner 230 optically scans a document conveyed from an auto document feeder (ADF) onto a contact glass or a document placed on the contact glass. Next, the scanner 230 reads a document image by forming, on a light receiving surface of a charge coupled device (CCD) sensor, an image of reflected light of light that is emitted from a light source to illuminate and scan the document. Next, the scanner 230 performs A/D conversion on the read image to generate image data.

The image forming section 240 forms an image on the sheet P based on image data. The image forming section 240 includes photosensitive drums 241Y, 241M, 241C, and 241K, charging sections 242Y, 242M, 242C, and 242K, exposure sections 243Y, 243M, 243C, and 243K, developing sections 244Y, 244M, 244C, and 244K, and primary transfer rollers 245Y, 245M, 245C, and 245K, corresponding to the respective colors of yellow (Y), magenta (M), cyan (C), and black (K). The image forming section 240 includes an intermediate transfer belt 246, a secondary transfer roller 247, and a fixing section 248.

The charging sections 242Y, 242M, 242C, and 242K uniformly charge the photosensitive drums 241Y, 241M, 241C, and 241K, respectively.

The exposure sections 243Y, 243M, 243C, and 243K include a laser light source, a polygon mirror, a lens, and the like. The exposure sections 243Y, 243M, 243C, and 243K scan and expose the surfaces of the photosensitive drums 241Y, 241M, 241C, and 241K, respectively, with laser beams to form electrostatic latent images according to the image data in respective colors.

The developing sections 244Y, 244M, 244C, and 244K develop the images by causing toner of the respective colors to adhere to the electrostatic latent images on the photosensitive drums 241Y, 241M, 241C, and 241K.

The primary transfer rollers 245Y, 245M, 245C, and 245K sequentially transfer the toner images in the respective colors formed on the photosensitive drums 241Y, 241M, 241C, and 241K, respectively, onto the intermediate transfer belt 246 (primary transfer). That is, the primary transfer rollers 245Y, 245M, 245C, and 245K form a color toner image in which the toner images of four colors are superimposed on the intermediate transfer belt 246.

The secondary transfer roller 247 collectively transfers the color toner image on the intermediate transfer belt 246 onto one surface of the sheet P supplied from the supply tray (secondary transfer). The fixing section 248 applies heat and pressure to the sheet P passing through a fixing nip portion of a fixing roller and a pressure roller, to thereby fix the toner image on the sheet P.

The conveyor 250 includes a predetermined conveyance path for conveying the sheet P, a plurality of conveyance rollers 251 provided along the conveying path, a reversing path 252, a registration section 253, and the like. The conveyor 250 conveys the sheet P along a predetermined conveyance path in the image forming device 200 by driving the conveyance rollers 251. The conveyor 250 conveys the sheet P after image formation to the post-processing device 300.

In single-sided printing in which an image is formed on one side of the sheet P in the image forming device 200, the conveyor 250 conveys the sheet P from the fixing section 248 to the post-processing device 300 under the control of the controller 210. On the other hand, in double-sided printing in which images are formed on both sides of the sheet P, the conveyor 250 conveys the sheet P from the fixing section 248 to a reversing path 252 under the control of the controller 210 to reverse the sheet surface. Next, the conveyor 250 feeds the sheet P again to the upstream side of the registration section 253 in the conveyance direction.

The registration section 253 includes a registration roller and conveys the sheet P to a transfer nip portion between the secondary transfer roller 247 and the intermediate transfer belt 246. The registration section 253 corrects the inclination of the sheet P conveyed through the conveyance path and adjusts the conveyance timing of the sheet P.

On the conveyance path of the sheet P, a plurality of sheet detection sensors 260 spaced at predetermined intervals are provided. Specifically, as shown in FIG. 1, a total of nine sheet detection sensors 260 are provided on the upstream side of the registration section 253, between the registration section 253 and the secondary transfer roller 247, on the downstream side of the fixing section 248, and in the reversing path 252.

The sheet detection sensors 260 detect a passing timing of each of a plurality of sheets P conveyed on the conveyance path. For example, the sheet detection sensors 260 detect passing timings of a leading end and a trailing end of the sheet P in the conveyance direction of the sheet P. The sheet detection sensors 260 output detection results to the controller 210.

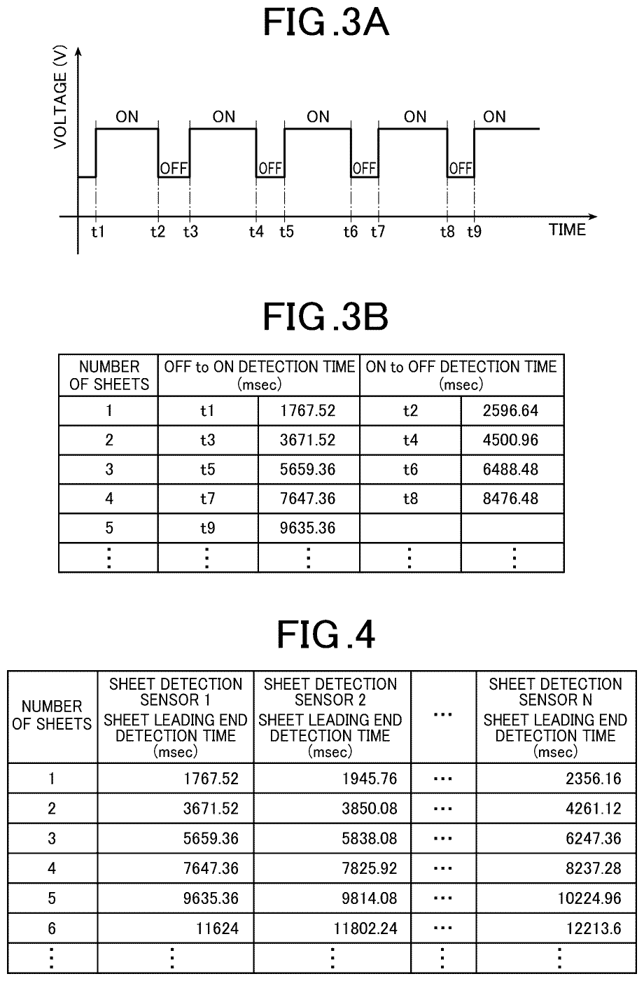

FIG. 3A shows an example of a detection signal of one sheet detection sensor 260. FIG. 3B shows timings when leading and trailing ends of sheets are detected by the sheet detection sensor 260. In the example shown in FIGS. 3A and 3B, Time t1 is a time when the sheet detection sensor 260 detects the leading end of the first sheet. Time t2 is a time when the sheet detection sensor 260 detects the trailing end of the first sheet. Time t3 is the time when the sheet detection sensor 260 detects the leading edge of the second sheet. Time t4 is the time when the sheet detection sensor 260 detects the trailing end of the second sheet. Time t5 is the time when the sheet detection sensor 260 detects the leading edge of the third sheet. Time t6 is the time when the sheet detection sensor 260 detects the trailing end of the third sheet. Time t7 is the time when the sheet detection sensor 260 detects the leading edge of the fourth sheet. Time t8 is the time when the sheet detection sensor 260 detects the trailing end of the fourth sheet. Time t9 is time when the sheet detection sensor 260 detects the leading edge of the fifth sheet.

The storage section 270 is a large-capacity auxiliary storage device that stores various programs including an operating system, various types of data, and the like. The storage of the storage section 270 is, for example, a hard disk, a solid state drive, a flash memory, a ROM, or the like.

The storage section 270 stores a state space model which will be described later.

The communicator 280 transmits and receives various setting values, various types of information required for operation timing control, and the like to and from other devices.

### 1-4. Configuration of Post-Processing Device

The post-processing device 300 is connected subsequently to the image forming device 200. The post-processing device 300 includes, for example, a plurality of post-processing units, and performs, in a post-processing unit specified by a job, predetermined post-processing on the sheet P on which an image has been formed in the image forming device 200. For example, the post-processing device 300 includes post-processing units that perform processing such as perforation processing, folding processing, foil stamping processing, binding, cutting processing, stapling, and gluing.

As shown in FIG. 1, the post-processing device 300 includes a conveyor 350. The conveyor 350 conveys the sheet P conveyed from the image forming device 200, on which image formation processing has been performed to a post-processing unit (not illustrated). The conveyor 350 discharges the post-processed sheet P to the sheet ejection tray 352 by the ejection section 351 provided along the conveyance path.

### 2. State Space Model

Next, the state space model stored in the storage section 270 of the image forming device 200 will be described. The controller 210 of the image forming device 200 stores the state space model in the storage section 270 by executing the following processing before the operation of the image forming apparatus 200.

Specifically, the controller 210 conveys the sheets P by the conveyor 250, and acquires detection results of the sheets P by the sheet detection sensors 260.

FIG. 4 shows an example of results of detection of the sheets P by the sheet detection sensors 260. In the example shown in FIG. 4, the detection results of the sheets P is times when the sheet detection sensors 260 detect the leading ends of the sheets P. The detection results of the sheets P may be times when the sheet detection sensor 260 detect the trailing ends of the sheets P.

The controller 210 generates a data set by arranging detection results of a plurality of sheets P in time series for each sheet detection sensor 260. Changes in the conveyance speeds of the sheet P can be calculated on the basis of the passing timings of the sheets P detected by the sheet detection sensors 260 and the arrangement positions of the sheet detection sensors 260. Therefore, a data set in which the detection results of the sheets P by each of the sheet detection sensors 260 are arranged in time series is a data set corresponding to the changes in the conveyance speeds of the sheets P in the image forming device 200.

The controller 210 acquires the detection results of the sheets P by the sheet detection sensors 260 in the normal state of the image forming device 200. Next, the controller 210 substitutes the data set (normal data set) generated based on the detection results in the normal state into the state space model and executes the identification calculation. The state space model is given by Equation (1) representing a state equation and Equation (2) representing an observation equation.

$$xt + 1 = Axt + But + Ket \qquad Equation ( 1 )$$

$$yt = Cxt + Dut + et \qquad Equation ( 2 )$$

In the above equations, xt is a state matrix, yt is an output vector, ut is an input vector, A, B, K, C, and D are coefficient matrices, and et is an error term.

That is, the controller 210 calculates the above A, B, K, C, and D (coefficient matrices) in the state space model using the normal data set. The state space model using the calculated coefficient matrices is defined as a normality model that is the state space model of the image forming device 200 in the normal state. The controller 210 stores the normality model in the storage section 270.

Alternatively, the controller 210 may store a normal model acquired from an external device via the communicator 280 in the storage section 270. In this case, the external device calculates the coefficient matrices of the state space model using the normal data set acquired from the image forming device 200. Next, the external device stores the state space model using the calculated coefficient matrices in the storage section of the external device as a normal model.

### 3. Operation of Image Forming System

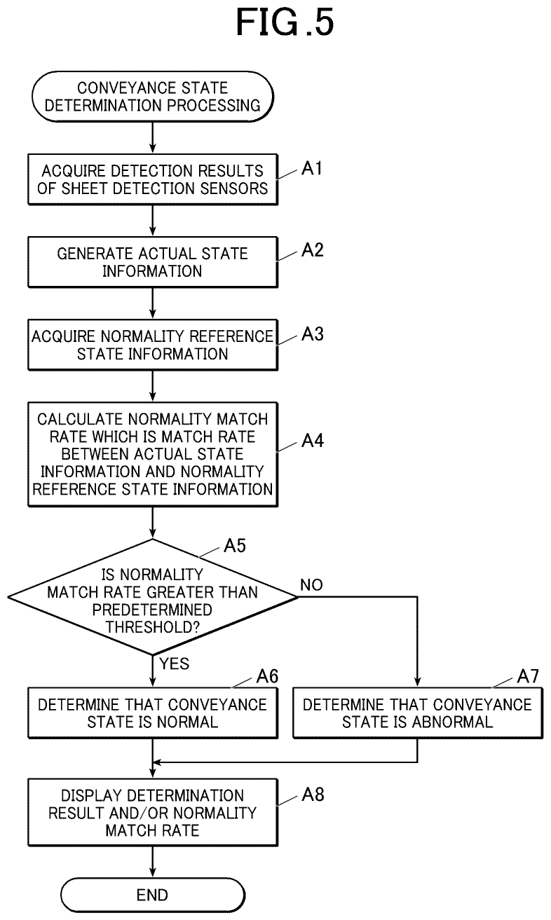

Next, the operation of the image forming system 10 according to the present embodiment will be described. The controller 210 of the image forming device 200 executes conveyance state determination processing shown in FIG. 5.

### Conveyance State Determination Processing

The controller 210 causes a plurality of sheets P to be fed from the sheet feed device 100. Next, the controller 210 causes, via the sheet information detection device 400, the plurality of sheets P to be conveyed on the conveyance path in the image forming device 200 and acquires detection results of the plurality of sheets P by the sheet detection sensors 260 (Step A1).

Next, the controller 210 generates actual state information, which is a data set in which the detection results of the plurality of sheets P acquired in Step A1 are arranged in time series, for each of the sheet detection sensors 260 (step A2).

That is, the actual state information includes a data set corresponding to the speed changes of the sheets according to the passing timings of the sheets in a plurality of sections in the conveyance path in the image forming device 200. The sections in the conveyance path in the image forming device 200 are each a section from an arrangement position of a predetermined sheet detection sensor 260 to an arrangement position of the next sheet detection sensor 260 in the conveyance direction.

The actual state information includes a data set corresponding to a speed change of the sheets according to passage timings of the plurality of sheets in the conveyance path in the image forming device 200.

In other words, the controller 210 acquires the actual state information corresponding to the speed changes of the sheets P in the conveyance path based on the detection results of the sheet detection sensors 260 arranged on the conveyance path of the sheets P. The controller 210 functions as a first acquirer. The controller 210 acquires the detection results of the sheet detection sensors 260 corresponding to the speed change of the sheets P in the conveyance path in real time.

Next, the controller 210 substitutes the actual state information generated in Step A2 into the normality model stored in the storage section 270 to acquire an estimated value by the normality model (Step A3). The estimated value by the normality model is reference state information in a normal state of the image forming device 200 (normality reference state information). That is, the controller 210 acquires the reference state information for comparison with the actual state information. The controller 210 functions as a second acquirer.

The reference state information includes a data set corresponding to speed changes of the sheets in the conveyance path in the image forming device 200 in the normal state of the conveyance device (the image forming device 200).

The reference state information includes a data set corresponding to speed changes of the sheets according to passing timings of the sheets in a plurality of sections in the conveyance path in the image forming device 200.

The reference state information includes a data set corresponding to a speed change of the sheets according to passage timings of the plurality of sheets in the conveyance path in the image forming device 200.

Next, the controller 210 calculates a normality match rate that is a match rate between the actual state information generated in Step A2 and the estimated value (the normality reference state information) by the normal model acquired in Step A3 (Step A4). In Step A4, the controller 210 calculates the normality match rate, which is fit, by calculating the interval correlation between the actual state information, which is u, and the estimated value by the normal model, which is y, using Equation (3).

$$[ Expression 1 ]$$

$$fit = 100 ( 1 - \frac{‖ u - y ‖}{‖ u - mean ( u ) ‖} ) \qquad Equation ( 3 )$$

Next, the controller 210 determines whether the normality match rate calculated in Step A4 is greater than a predetermined threshold (e.g., 50%) (Step A5).

When the normality match rate is greater than the predetermined value (Step A5; YES), the controller 210 determines that the conveyance state of the sheet P by the conveyor 250 is the normal state (Step A6).

On the other hand, when the normality match rate is equal to or smaller than the predetermined value (Step A5; NO), the controller 210 determines that the conveyance state of the sheet P by the conveyor 250 is the abnormal state (Step A7).

After execution of Step A6 or A7, the controller 210 displays the determination result and/or the normality match rate in Step A6 or step A7 on the display of the operation display section 220 (Step A8). That is, the controller 210 compares the actual state information with the reference state information, thereby outputting evaluation information for evaluating the state of the conveyance device (the image forming device 200) that conveys the sheets along the conveyance path. The controller 210 functions as an output section. The evaluation information in the present embodiment is information corresponding to the normality or abnormality of the conveyance device.

In Step A8, the controller 210 notifies the user of the evaluation information by showing it on the display of the operation display section 220. The controller 210 functions as a notifier.

Next, the controller 210 ends the conveyance state determination processing.

### 4. Modification Examples 2

### 4-1. Modification Example 1

Next, Modification Example 1 of the present embodiment will be described. In Modification Example 1, the components similar to those of the above-described embodiment are denoted by the same reference numerals, and the description thereof will be omitted.

The state space model stored in the storage section 270 of Modification Example 1 includes an abnormality model. The controller 210 of the image forming device 200 stores the abnormality model in the storage section 270 by executing the following processing before the operation of the image forming device 200.

Specifically, in a predetermined abnormal state of the image forming device 200, the controller 210 conveys a plurality of sheets P by the conveyor 250 and acquires detection results of the plurality of sheets P by the sheet detection sensors 260. The controller 210 arranges, in time series, the detection results of the plurality of sheets P by the sheet detection sensors 260 to generate a data set on the abnormal state (the abnormality data set). The controller 210 calculates coefficient matrices of the state space model using the abnormality data set. Next, the controller 210 stores the state space model using the calculated coefficient matrices in the storage section 270 as an abnormality model.

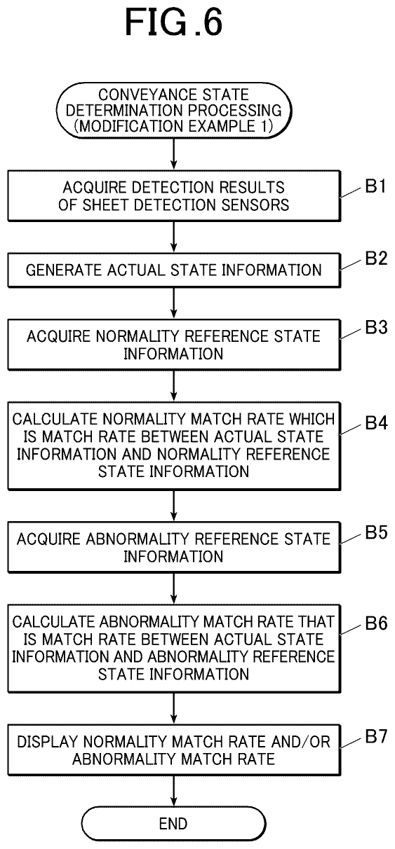

Next, the conveyance state determination processing of Modification Example 1 shown in FIG. 6 will be described.

### Conveyance State Determination Processing of Modification Example 1

The controller 210 executes Steps A1 to A4 similar to Steps B1 to B4 of the conveyance state determination processing of the above-described embodiment.

Next, the controller 210 substitutes the actual state information generated in Step B2 into the abnormality model stored in the storage section 270 to acquire an estimated value by the abnormality model (Step B5). The estimated value by the abnormality model is reference state information in the abnormal state of the image forming device 200 (abnormality reference state information).

The reference state information includes a data set corresponding to speed changes of the sheets in the conveyance path in the image forming device 200 in the predetermined abnormal state of the conveyance device (the image forming device 200).

Next, the controller 210 calculates an abnormality match rate which is a match rate between the actual state information generated in Step B2 and the estimated value (abnormality reference state information) by the abnormality model acquired in Step B5 (Step B6). In Step B6, the controller 210 calculates, by Equation (3) above, the abnormality match rate which is fit by taking a section correlation between the actual state information which is u and the estimated value by the abnormality model which is y.

Next, the controller 210 displays the normal match rate calculated in Step B4 and/or the abnormal match rate calculated in Step B6 on the display of the operation display section 220 (Step B7), and the conveyance state is set.

The state determination processing ends.

That is, the controller 210 outputs, as the evaluation information, the match rate (normal match rate) between the actual state information and the reference state information (normal reference state information) in the normal state of the conveyance device (the image forming device 200). Alternatively, the controller 210 outputs, as the evaluation information, the match rate (abnormality match rate) between the actual state information and the reference state information (abnormal reference state information) in the predetermined abnormal state of the conveyance device (the image forming device 200).

### 4-2. Modification Example 2

Next, Modification Example 2 of the present embodiment will be described. In Modification Example 2, the components similar to those of the above-described embodiment are denoted by the same reference numerals, and the description thereof will be omitted.

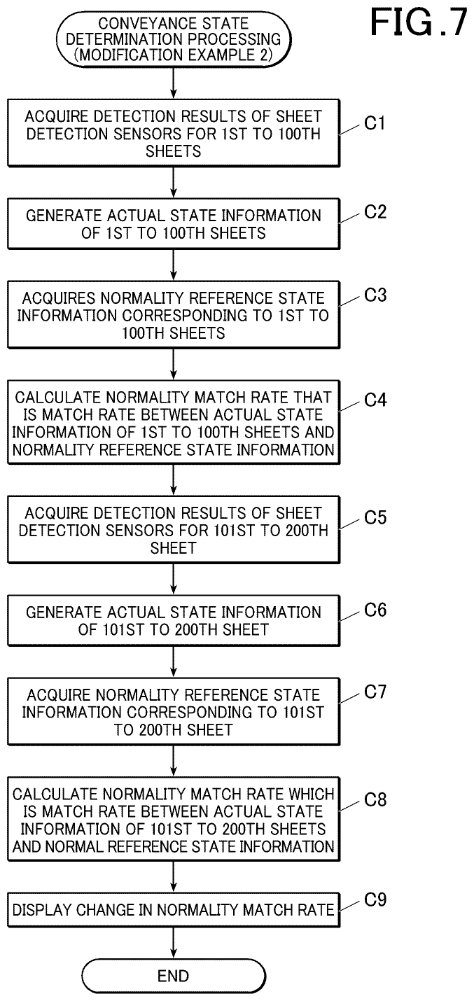

Next, the conveyance state determination processing of Modification Example 2 shown in FIG. 7 will be described.

### Conveyance State Determination Processing of Modification Example 2

The controller 210 causes a predetermined number (e.g., 100) of sheets P to be fed from the sheet feed device 100. Next, the controller 210 causes the predetermined number of sheets P to be conveyed on the conveyance path in the image forming device 200 and acquires detection results of the predetermined number of sheets P (the 1st to 100th sheets) by the sheet detection sensors 260 (Step C1).

Next, the controller 210 generates actual state information on the 1st to 100th sheets P on the basis of the detection results of the 1st to 100th sheets P by the sheet detection sensors 260 acquired in Step A1 (Step C2).

Next, the controller 210 substitutes the actual state information of the 1st to 100th sheets P generated in Step C2 into the normality model stored in the storage section 270 and acquires an estimated value (normal reference state information) by the normality model (Step C3).

Next, the controller 210 calculates a normality match rate which is a match rate between the actual state information of the 1st to 100th sheets P generated in Step C2 and the normality reference state information for the 1st to 100th sheets P acquired in Step C3 (Step C4).

Next, the controller 210 causes the sheet feed device 100 to further feed a predetermined number (e.g., 100) of sheets P. Next, the controller 210 causes the predetermined number of sheets P to be conveyed on the conveyance path in the image forming device 200 and acquires detection results of the predetermined number of sheets P (the 101st to 200th sheets) by the sheet detection sensors 260 (Step C5).

Next, the controller 210 generates actual state information on the 101st to 200th sheets P based on the detection results of the 101st to 200th sheets P by the sheet detection sensors 260 acquired in Step C5 (Step C6).

Next, the controller 210 substitutes the actual state information of the 101st to 200th sheets P generated in Step C6 into the normality model stored in the storage section 270 to acquire an estimated value (normality reference state information) by the normality model (Step C7).

Next, the controller 210 calculates a normality match rate which is a match rate between the actual state information on the 101st to 200th sheets P generated in Step C6 and the normality reference state information for the 101st to 200th sheets P acquired in Step C7 (Step C8).

Next, the controller 210 displays the normality match rate for the 1st to 100th sheets P calculated in Step C4 and the normality match rate for the 101st to 200th sheets P calculated in Step C8 on the display of the operation display section 220 (Step S9). Accordingly, the controller 210 displays information indicating a change in the normality matching rate. Next, the controller 210 ends the conveyance state determination processing.

In the conveyance state determination processing of Modification Example 2, the controller 210 may execute the following processing. Specifically, the controller 210 substitutes the actual state information of the 1st to 100th sheets P into the abnormality model stored in the storage section 270 to acquire an estimated value (abnormality reference state information) by the abnormality model.

Next, the controller 210 calculates an abnormality match rate which is a match rate between the actual state information of the 1st to 100th sheets P and the abnormality reference state information for the 1st to 100th sheets P. Next, the controller 210 substitutes the actual state information on the 101st to 200th sheets P into the abnormality model to acquire an estimated value (abnormality reference state information) by the abnormality model. Next, the controller 210 calculates an abnormality match rate which is a match rate between the actual state information of the 101st to 200th sheets P and the abnormality reference state information for the 101st to 200th sheets P. Next, the controller 210 causes the display of the operation display section 220 to display the abnormality match rate for the 1st to 100th sheets P and the abnormality match rate for the 101st to 200th sheets P. Thus, the controller 210 displays information indicating a change in the abnormality match rate.

That is, the controller 210 outputs, as the evaluation information, information indicating a change in the match rate (normal match rate) between the actual state information and the reference state information (normal reference state information) in the normal state of the conveyance device (the image forming device 200). Alternatively, the controller 210 outputs, as the evaluation information, information indicating a change in the match rate (abnormality match rate) between the actual state information and the reference state information (abnormal reference state information) in the predetermined abnormal state of the conveyance device.

### 4-3. Modification Example 3

Next, Modification Example 3 of the present embodiment will be described. In Modification Example 3, the components similar to those of the above-described embodiment are denoted by the same reference numerals, and the description thereof will be omitted.

The state space model stored in the storage section 270 of Modification Example 3 includes abnormality models corresponding to a plurality of types of abnormal states. The controller 210 of the image forming device 200 stores a plurality of types of abnormality models in the storage section 270 by executing the following processing before the operation of the image forming device 200.

Specifically, in a state where a roller A of the conveyance rollers 251 is deteriorated, the controller 210 conveys a plurality of sheets P by the conveyor 250 and acquires detection results of the plurality of sheets P by the sheet detection sensors 260. A jam occurring in the conveyance of the sheet P due to the deterioration of the roller A is defined as jam A. The controller 210 arranges, in time series, the detection results of the plurality of sheets P by the sheet detection sensors 260 to generate a data set in the abnormal state where jam A is likely to occur (jam A data set). Next, the controller 210 calculates coefficient matrices of the state space model using the jam A data set. Next, the controller 210 stores the state space model using the calculated coefficient matrices as a jam A model in the storage section 270.

Further, when the speed of the motor driving the conveyance rollers 251 is in an abnormal state, the controller 210 conveys a plurality of sheets P by the conveyor 250 and acquires detection results of the plurality of sheets P by the sheet detection sensors 260. A jam occurring in the conveyance of the sheet P due to an abnormality in the speed of the motor that drives the conveyance rollers 251 is referred to as jam B. The controller 210 arranges, in time series, the detection results of the plurality of sheets P by the sheet detection sensors 260 to generate a data set in the abnormal state where jam B is likely to occur (jam B data set). Next, the controller 210 calculates coefficient matrices of the state space model using the jam B data set. Next, the controller 210 stores the state space model using the calculated coefficient matrices as a jam B model in the storage section 270.

Further, in a state where the temperature inside the image forming device 200 abnormally increases, the controller 210 conveys a plurality of sheets P by the conveyor 250 and acquires detection results of the plurality of sheets P by the sheet detection sensors 260. A jam occurring in the conveyance of the sheet P due to an abnormal increase in the temperature in the image forming device 200 is referred to as jam C. The controller 210 arranges, in time series, the detection results of the plurality of sheets P by the sheet detection sensors 260 to generate a data set in the abnormal state where jam C is likely to occur (jam C data set). Next, the controller 210 calculates coefficient matrices of the state space model using the jam C data set.

Next, the controller 210 stores the state space model using the calculated coefficient matrices as a jam C model in the storage section 270.

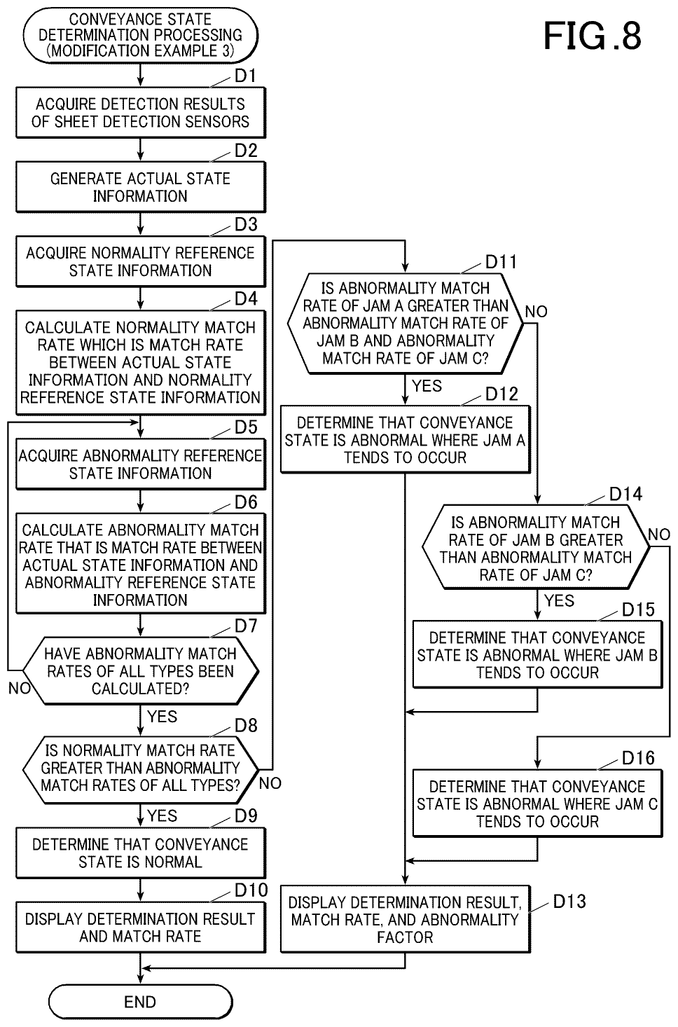

Next, the conveyance state determination processing of Modification Example 3 shown in FIG. 8 will be described.

### Conveyance State Determination Processing of Modification Example 3

The controller 210 executes Steps A1 to A4 similar to Steps D1 to D4 of the conveyance state determination processing of the above-described embodiment.

Next, the controller 210 substitutes the actual state information generated in Step D2 into one of the abnormality models stored in the storage section 270 to acquire an estimated value (abnormality reference state information) by the abnormality model (Step D5).

The estimated value by the jam A model is reference state information corresponding to the deterioration state of the roller A of the conveyance rollers 251.

The estimated value by the jam B model is reference state corresponding to the speed abnormal state of the motor that drives the conveyance rollers 251.

The estimated value according to the jam C model is reference state information corresponding to a trend of the conveyance time of the sheet P when the diameter of the conveyance roller 251 abnormally expands due to an abnormal increase in the temperature in the image forming device 200.

Next, the controller 210 calculates an abnormality match rate which is a match rate between the actual state information generated in Step D2 and the estimated value (abnormality reference state information) by the abnormality model acquired in Step D5 (Step D6). The match rate between the actual state information and the estimated value by the jam A model is set as the abnormality match rate of the jam A. The match rate between the actual state information and the estimated value by the jam B model is set as the abnormality match rate of the jam B. The match rate between the actual state information and the estimated value by the jam C model is set as the abnormality match rate of the jam C.

Next, the controller 210 determines whether all types of abnormality match rates have been calculated (Step D7).

In a case where there is an abnormality match rate which is not calculated (Step D7; NO), the controller 210 causes the conveyance state determination processing to proceed to Step D5.

On the other hand, when all types of the abnormality match rates have been calculated (Step D7; YES), the controller 210 determines whether or not the normality match rate calculated in Step D4 is greater than all types of the abnormality match rates (Step D8).

In a case where the normality match rate is greater than the abnormality match rates of all types (Step D8; YES), the controller 210 determines that the conveyance state of the sheet P by the conveyor 250 is the normal state (Step D9).

Next, the controller 210 causes the display of the operation display section 220 to display the determination result in Step D9, the normality match rate, and all types of the abnormality match rates (Step D10), and ends the conveyance state determination processing.

On the other hand, when the normality match rate is equal to or smaller than any one of the abnormality match rates (Step D8; NO), the controller 210 determines whether or not the abnormality match rate for the jam A is greater than the other types of abnormality match rates (the abnormality match rate for the jam B and the abnormality match rate for the jam C) (Step D11).

If the abnormality match rate for the jam A is greater than the abnormality match rates of the other types (Step D11: YES), the controller 210 determines that the conveyance state of the sheet P by the conveyor 250 is an abnormality state in which jam A tends to occur (Step D12).

Next, the controller 210 shows, on the display of the operation display section 220, the determination result in Step D12, the normal match rate, all types of abnormality match rates, and the abnormality factor (Step D13), and ends the conveyance state determination processing.

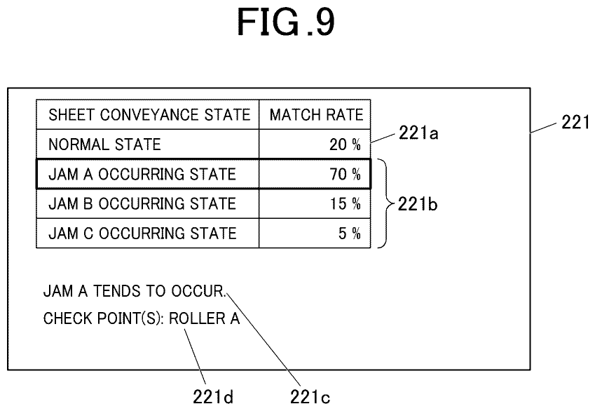

FIG. 9 shows an example of a display screen 221 that the controller 210 displays on the display of the operation display section 220 in Step D13.

In the example shown in FIG. 9, the controller 210 shows, on the display screen 221, a normality match rate 221a, all types of abnormal match rates 221b, a determination result 221c in Step D12, and a factor 221d of jam A.

On the other hand, when the abnormality match rate of the jam A is equal to or smaller than any of the other abnormality match rates (Step D11; NO), the controller 210 determines whether or not the abnormality match rate for the jam B is greater than the abnormality match rate for the jam C (Step D14).

If the abnormality match rate for the jam B is greater than the abnormality match rate for the jam C (Step D14; YES), the controller 210 determines that the conveyance state of the sheet P by the conveyor 250 is an abnormality state in which jam B tends to occur (step D15).

Next, the controller 210 causes the conveyance state determination processing to proceed to Step S13 to show on the display of the operation display section 220, the determination result in Step D15, the normal match rate, all types of abnormality match rates, and the abnormality factor, and ends the conveyance state determination processing.

On the other hand, when the abnormality match rate for the jam B is equal to or smaller than the abnormality match rate for the jam C (Step D14; NO), the controller 210 determines that the conveyance state of the sheet P by the conveyor 250 is an abnormality state in which jam C tends to occur (Step D16).

Next, the controller 210 causes the conveyance state determination processing to proceed to Step S13 to show on the display of the operation display section 220, the determination result in Step D16, the normal match rate, all types of abnormality match rates, and the abnormality factor, and ends the conveyance state determination processing.

That is, the controller 210 outputs, as the evaluation information, the match rate (abnormality match rate) between the actual state information for each type of the abnormal state of the conveyance device (the image forming device 200) and the reference state information (abnormality reference state information) in the abnormal state of the conveyance device.

### 4-4. Modification Example 4

Next, Modification Example 4 of the present embodiment will be described. In Modification Example 4, the components similar to those of the above-described embodiment are denoted by the same reference numerals, and the description thereof will be omitted.

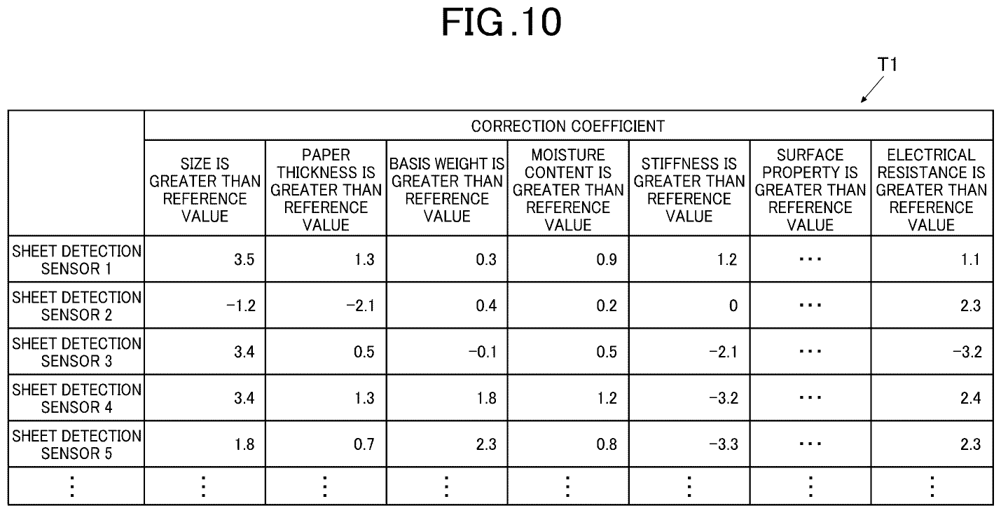

The storage section 270 of Modification Example 4 stores a correction coefficient table T1. As shown in FIG. 10, the correction coefficient table T1 stores, for each type of sheet characteristic information of the sheet P detected by the media sensors 430 and for each sheet detection sensor 260, a correction coefficient for correcting the detection results by the sheet detection sensors 260.

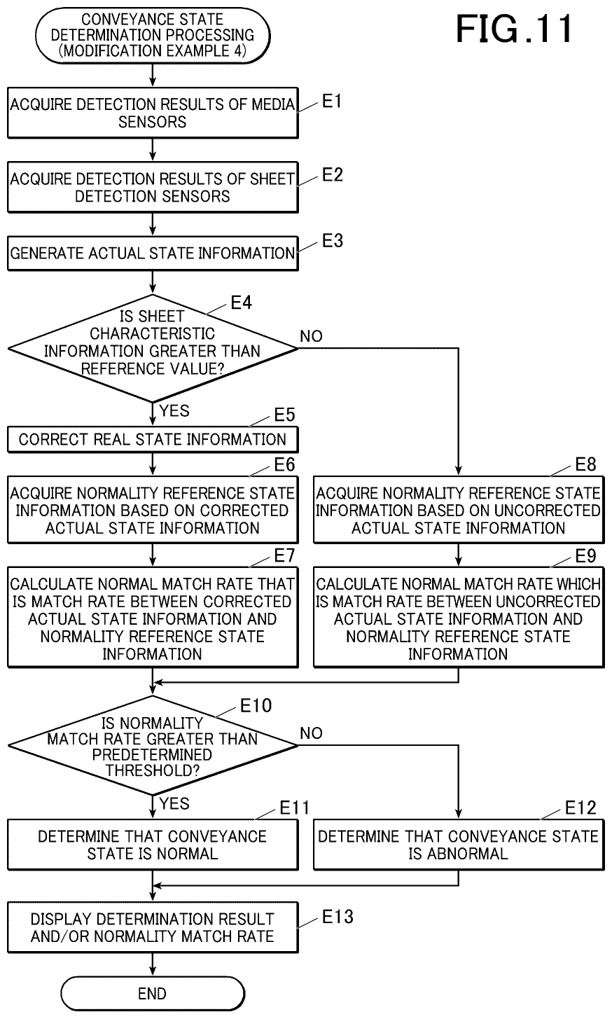

Next, the conveyance state determination processing of Modification Example 4 shown in FIG. 11 will be described.

### Conveyance State Determination Processing of Modification Example 4

The controller 210 causes a plurality of sheets P to be fed from the sheet feed device 100. Next, the controller 210 acquires sheet characteristic information which is a detection result of any one of the sheets P by the media sensor 430 of the sheet information detection device 400 (Step E1). In Step E1, the controller 210 acquires the size, paper thickness, basis weight, moisture content, surface properties, and stiffness of the paper P as the sheet characteristic information.

Next, the controller 210 conveys the plurality of sheets P on the conveyance path in the image forming device 200 and acquires the detection results of the plurality of sheets P by the plurality of sheet detection sensors 260 (Step E2).

Next, the controller 210 generates actual state information on the basis of the detection results of the plurality of sheets P by the sheet detection sensors 260 acquired in Step E2 (step E3).

Next, the controller 210 determines whether or not each piece of the sheet characteristic information on the sheet P acquired in Step E1 is greater than a predetermined reference value (Step E4).

When the sheet characteristic information of the sheet P is greater than the predetermined reference value (Step E4; YES), the controller 210 corrects the actual state information generated in Step E3 by the correction coefficient stored in the correction coefficient table T1 (Step E5). In the example shown in FIG. 10, for example, when the moisture content of the sheet P is larger than a predetermined reference value, the controller 210 corrects the actual state information by performing the following processing. Specifically, the controller 210 multiplies the detection result of the first sheet detection sensor 260 by the correction coefficient “0.9”. Then, the controller 210 multiplies the detection result of the second sheet detection sensor 260 by the correction coefficient “0.2”. Then, the controller 210 multiplies the detection result of the third sheet detection sensor 260 by the correction coefficient “0.5”. Then, the controller 210 multiplies the detection result of the fourth sheet detection sensor 260 by the correction coefficient “1.2”. Then, the controller 210 multiplies the detection result of the fifth sheet detection sensor 260 by the correction coefficient “0.8”.

Next, the controller 210 substitutes the actual state information corrected in Step E5 into the normality model stored in the storage section 270 to acquire an estimated value (normality reference state information) by the normality model (Step E6).

Next, the controller 210 calculates a normality match rate which is a match rate between the actual state information corrected in Step E5 and the normal reference state information acquired in Step E6 (Step E7).

On the other hand, in a case where the sheet characteristic information of the sheet P is equal to or smaller than the predetermined reference value (Step E4; NO), the controller 210 substitutes the actual state information generated in Step E3 into the normality model stored in the storage section 270 and acquires an estimated value (normal reference state information) by the normality model (Step E8).

Next, the controller 210 calculates a normality match rate which is a match rate between the actual state information generated in Step E3 and the normal reference state information acquired in Step E8 (Step E9).

After execution of Step E7 or E9, the controller 210 executes Steps E10 to E13 similar to Steps A5 to A8 of the conveyance state determination processing of the above-described embodiment and ends the conveyance state determination processing.

In Step E6 of the conveyance state determination processing of Modification Example 4 described above, the controller 210 may substitute the uncorrected actual state information generated in Step E3 into the normality model to acquire an estimated value by the normality model. In this case, in Step E7, the controller 210 calculates a normality match rate which is a match rate between the actual state information corrected in Step E5 and an estimated value by the normality model based on the actual state information which is not corrected.

Alternatively, in Step E7 of the transport state determination processing of Modification Example 4 described above, the controller 210 may calculate a normality match rate which is a match rate between the actual state information generated in Step E3 which is not corrected and the estimated value by the normality model based on the corrected actual state information.

### 5. Effect

As described above, the conveyance state determination system (image forming system 10) according to the present embodiment includes the first acquirer (controller 210) that acquires the actual state information corresponding to a speed change of a sheet in the conveyance path based on detection results of the plurality of sheet detection sensors 260 disposed on the conveyance path of the sheet.

The conveyance state determination system according to the present embodiment includes the second acquirer (controller 210) that acquires the reference state information for comparison with the actual state information.

The conveyance state determination system according to the present embodiment includes the output section (controller 210) that outputs the evaluation information for evaluating the state of the conveyance device (image forming device 200) that conveys sheets through the conveyance path by comparing the actual state information with the reference state information.

Therefore, since the evaluation information on the state of the conveyance device can be grasped before a jam occurs in the conveyance of the sheet P, the jam can be prevented in advance on the basis of the evaluation information. Thus, waste of sheets and a decrease in productivity can be suppressed.

In the conveyance state determination system (image forming system 10) according to the present embodiment, the evaluation information is information corresponding to whether the conveyance device (image forming device 200) is normal or abnormal. Therefore, since whether the conveyance device is in a normal state or an abnormal state can be grasped before a jam occurs in the conveyance of the sheet P, the jam can be prevented in advance.

In the conveyance state determination system (image forming system 10) according to the present embodiment, the evaluation information is the match rate between the actual state information and the reference state information in the normal state of the conveyance device (image forming device 200), or the match rate between the actual state information and the reference state information in the predetermined abnormal state of the conveyance device.

Therefore, before a jam occurs in the conveyance of the sheet P, it is possible to grasp the match rate between the current state and the normal state or the match rate between the current state and the abnormal state of the conveyance device. Thus, a jam can be prevented in advance.

In the conveyance state determination system (image forming system 10) according to the present embodiment, the evaluation information is information indicating a change in the match rate between the actual state information and the reference state information in the normal state of the conveyance device (image forming device 200), or information indicating a change in the match rate between the actual state information and the reference state information in the predetermined abnormal state of the conveyance device.

Therefore, before a jam occurs in the conveyance of the sheet P, it is possible to grasp a change in the match rate between the current state and the normal state of the conveyance device or a change in the match rate between the current state and the abnormal state. Thus, a jam can be prevented in advance.

In the conveyance state determination system (image forming system 10) according to the present embodiment, the reference state information includes a data set corresponding to a speed change of a sheet in the conveyance path in the normal state of the conveyance device (image forming device 200).

Therefore, before a jam occurs in the conveyance of the sheet P, it is possible to grasp a result of comparison between the current speed change of the sheet and the speed change of a sheet in the normal state of the conveyance device. Thus, a jam can be prevented in advance.

In the conveyance state determination system (image forming system 10) according to the present embodiment, the reference state information includes a data set corresponding to a speed change of the sheet in the conveyance path in the normal state of the conveyance device (image forming device 200) a data set corresponding to a speed change of a sheet in the conveyance path in a predetermined abnormal state of the conveyance device.

Therefore, before a jam occurs in the conveyance of the sheet P, it is possible to grasp the result of comparison between the current change in the speed of the sheet and the change in the speed of a sheet in the normal state of the conveyance device. In addition, it is possible to grasp the result of comparison between the current speed change of the sheet and the speed change of a sheet in a predetermined abnormal state of the conveyance device. Thus, a jam can be prevented in advance.

In the conveyance state determination system (the image forming system 10) according to the present embodiment, the actual state information and the reference state information include a data set corresponding to the speed change of the sheet according to the passage timings of the sheet in a plurality of sections in the conveyance path.

Therefore, data corresponding to the conveyance state of the sheet in the conveyance path can be easily acquired.

In the conveyance state determination system (the image forming system 10) according to the present embodiment, the actual state information and the reference state information include a data set corresponding to a speed change of the sheets according to passing timings of the plurality of sheets in the conveyance path.

Therefore, data corresponding to the conveyance state of the sheet in the conveyance path can be easily acquired.

In the conveyance state determination system (image forming system 10) according to the present embodiment, the reference state information includes an estimated value by the state space model.

Therefore, it is possible to easily acquire the reference state information for comparison with the actual state information.

In the conveyance state determination system (the image forming system 10) according to the present embodiment, at least one of the actual state information and the reference state information includes a data set corrected based on the sheet characteristic information indicating the characteristics of the sheet.

Therefore, it is possible to grasp more accurate evaluation information on the state of the conveyance device according to the characteristics of the sheet.

In the conveyance state determination system (image forming system 10) according to the present embodiment, the sheet characteristic information is information corresponding to the characteristics of the sheet detected by the media sensor.

Therefore, the sheet characteristic information can be easily acquired.

The conveyance state determination system (image forming system 10) according to the present embodiment includes the notifier (controller 210) that notifies a user of the evaluation information.

Therefore, since a user can grasp the evaluation information on the state of the conveyance device before a jam occurs in the conveyance of the sheet P, the jam can be prevented in advance on the basis of the evaluation information.

In the conveyance state determination system (image forming system 10) according to the present embodiment, the evaluation information is a match rate between the actual state information for each type of the abnormal state of the conveyance device and the reference state information in the abnormal state of the conveyance apparatus.

Therefore, since the type of the abnormal state having a relatively high match rate can be grasped before the jam occurs in the conveyance of the sheet P, the jam is easily prevented in advance.

In the conveyance state determination system (image forming system 10) according to the present embodiment, the first acquirer (controller 210) acquires, in real time, the detection results of the plurality of sheet detection sensors corresponding to the speed change of the sheets in the conveyance path.

Therefore, the data corresponding to the current conveyance state of the sheets in the conveyance path can be easily acquired.

Although the present invention has been described in detail based on the embodiment, the present invention is not limited to the above-described embodiment. The embodiment can be modified without departing from the spirit and scope of the invention.

For example, although the controller 210 acquires physical property values detected by the media sensors 430 as the sheet characteristic information in the above embodiment, it is not limited thereto. The controller 210 may acquire a physical property value based on sheet information set by a user via the operation display section 220. That is, the controller 210 acquires, as the sheet characteristic information, the physical property values of the sheet P on the basis of the sheet information such as the paper type, the basis weight, and the size of the sheet P.

Furthermore, although the controller 210 functions as the “first acquirer”, the “second acquirer”, the “output section”, and the “notifier” in the embodiment described above, it is not limited thereto. The image forming system 10 may include an external device communicably connected to the image forming device 200, and the external device may function as the “first acquirer”, the “second acquirer”, the “output section”, and the “notifier.”

Besides, the detailed configuration of each device constituting the image forming system and the detailed operation of each device can also be appropriately modified without departing from the spirit and scope of the present invention.

Although embodiments of the present invention have been described and shown in detail, the disclosed embodiments are made for purposes of illustration and example only and not limitation. The scope of the present invention should be interpreted by terms of the appended claims.

What is claimed is:

1. A conveyance state determination system comprising:
a controller,
wherein the controller:
acquires actual state information corresponding to a speed change of a sheet on a conveyance path of the sheet based on detection results of a plurality of sheet detection sensors disposed on the conveyance path;
acquires reference state information to be compared with the actual state information; and
compares the actual state information and the reference state information to output evaluation information for evaluating a state of a conveyance device that conveys the sheet through the conveyance path.

2. The conveyance state determination system according to claim 1,
wherein the evaluation information is information corresponding to normality or abnormality of the conveyance device.

3. The conveyance state determination system according to claim 1,
wherein the evaluation information is a match rate between the actual state information and the reference state information in a normal state of the conveyance device or a match rate between the actual state information and the reference state information in a predetermined abnormal state of the conveyance device.

4. The conveyance state determination system according to claim 1,
wherein the evaluation information is information indicating a change in a match rate between the actual state information and the reference state information in a normal state of the conveyance device, or information indicating a change in a match rate between the actual state information and the reference state information in a predetermined abnormal state of the conveyance device.

5. The conveyance state determination system according to claim 1,
wherein the reference state information includes a data set corresponding to a speed change of the sheet on the conveyance path in a normal state of the conveyance device.

6. The conveyance state determination system according to claim 1,
wherein the reference state information includes a data set corresponding to a speed change of the sheet on the conveyance path in a normal state of the conveyance device, and a data set corresponding to a speed change of the sheet on the conveyance path in a predetermined abnormal state of the conveyance device.

7. The conveyance state determination system according to claim 1,
wherein the actual state information and the reference state information include a data set corresponding to a speed change of the sheet according to passing timings of the sheet in a plurality of sections in the conveyance path.

8. The conveyance state determination system according to claim 1,
wherein the actual state information and the reference state information include a data set corresponding to a speed change or speed changes of a plurality of sheets according to passing timings of the plurality of sheets in the conveyance path.

9. The conveyance state determination system according to claim 1,
wherein the reference state information includes an estimated value by a state space model.

10. The conveyance state determination system according to claim 1,
wherein at least one of the actual state information and the reference state information includes a data set corrected based on sheet characteristic information indicating a characteristic of the sheet.

11. The conveyance state determination system according to claim 10,
wherein the sheet characteristic information is information corresponding to the characteristic of the sheet detected by a media sensor.

12. The conveyance state determination system according to claim 1,
wherein the controller notifies a user of the evaluation information.

13. The conveyance state determination system according to claim 1,
the evaluation information is a match rate between the actual state information in an abnormality state of the conveyance device and the reference state information in the abnormality state of the conveyance device, the abnormality state including a plurality of types of abnormality states.

14. The conveyance state determination system according to claim 1,
wherein the controller acquires, in real time, the detection results of the plurality of sheet detection sensors corresponding to a speed change of the sheet in the conveyance path.

15. A non-transitory computer-readable storage medium storing a program for causing a computer to function as:
a first acquirer that acquires actual state information corresponding to a speed change of a sheet on a conveyance path of the sheet based on detection results of a plurality of sheet detection sensors disposed on the conveyance path;
a second acquirer that acquires reference state information to be compared with the actual state information; and
an output section that outputs evaluation information for evaluating a state of a conveyance device that conveys the sheet through the conveyance path by comparing the actual state information and the reference state information.
